(19) United States
(12) Patent Application Publication
(10) Pub. No.: US 2018/0362169 A1
(43) Pub. Date: Dec. 20, 2018

(54) AIRCRAFT WITH ELECTRIC AND FUEL ENGINES

(71) Applicant: Xing Du, Newport Beach, CA (US)

(72) Inventor: Xing Du, Newport Beach, CA (US)

(21) Appl. No.: 15/625,583

(22) Filed: Jun. 16, 2017

(51) Int. Cl. B64D 27/24; B64C 29/02; B64C 11/30; B64C 11/28; B64C 25/36; H02K 7/18; H02K 7/108; H02K 7/14

(52) U.S. Cl. CPC B64D 27/24; B64C 29/02; B64C 11/30; B64C 11/28; B64D 2027/026; H02K 7/1815; H02K 7/108; H02K 7/14; B64C 25/36

(57) ABSTRACT

An aircraft, such as an unmanned aerial vehicle or a small-sized manned aircraft, can be hybrid-powered by fuel engines and electric motors. In various embodiments, such an aircraft can include both of rotors and fixed wings, and can perform vertical take-off and landing like a helicopter and level flight like a fixed-wing aircraft.

### TECHNICAL FIELD

This document relates generally to aircraft and more particularly to aircrafts and methods for their operation using both electric and fuel engines.

### BACKGROUND

Existing unmanned aerial vehicles may use rotors to for vertical take-off and level flight, and use battery-powered electric motors to drive the rotors. Such unmanned aerial vehicles have small take-off payloads, shorter air-ranges, and slow speed during level flight.

### SUMMARY

An aircraft, such as an unmanned aerial vehicle or a small-sized manned aircraft, can be hybrid-powered by fuel engines and electric motors. In various embodiments, such an aircraft can include both of rotors and fixed wings, and can perform vertical take-off and landing like a helicopter and level flight like a fixed-wing aircraft.

In various embodiments, an aircraft can include a plurality of propulsion units. The plurality of propulsion units includes fuel propulsion units and electric propulsion units. It should be understood that while “fuel propulsion units” and “electric propulsion units” are used for the purpose of illustration and discussion, the aircraft can include one or more fuel propulsion units and one or more electric propulsion units in various embodiments. The fuel propulsion units can be driven by fuel engines. Each of the electric propulsion units can include one or more electric rotors or duct fans driven by an electric motor. It should be understood that while electric rotor is used for the purpose of illustration and discussion, each electric rotor in the various embodiments discussed in this document can be replaced by an electric ducted fan. The propulsion direction of the fuel propulsion units is substantially perpendicular to a rotation plane of the electric rotor, such that that the fuel propulsion units and the electric propulsion units can operate simultaneously to perform a vertical flight of the aircraft. As the aircraft includes both of the fuel propulsion units and the electric rotors, it not only can carry heavier items but also can more easily and accurately control its balance and posture. The weight of the aircraft can be balanced out by the lift force of the rotors, so the hovering time can be longer than that of a multi-rotor aircraft driven by batteries.

Optionally, the aircraft further includes a fixed wing. The fixed wing is substantially parallel to the propulsion direction of the plurality of propulsion units, so that at least part of the plurality of propulsion units including the fuel propulsion unit can be cooperated with the fixed wing to perform the level flight of the aircraft. During the level flight of the aircraft, the flying direction may be substantially parallel to the fixed wing. As the aircraft further includes the fixed wing, it can perform rapid level flight like a conventional fixed-wing aircraft. As the propulsion for level-flight is provided by the fuel propulsion units while the lift force is provided by the fixed wing, the speed and the air-range of the aircraft can be greatly increased. When the fuel propulsion units fail, the aircraft can use the battery-powered electric propulsion units as backup for landing.

Optionally, during the level flight, the aircraft is propelled by the fuel propulsion units, or propelled by the fuel propulsion units and the electric propulsion units simultaneously. The aircraft uses at least the fuel propulsion units to provide power for level-flight and hence can increase its speed and air-range. In addition, optionally, the power can be provided by the fuel propulsion units and the electric rotors simultaneously, so that the total power can be increased and the flight speed can be further increased.

Optionally, the aircraft includes a plurality of electric rotors that are distributed on both sides of the fixed wing, so that the flying posture of the aircraft can be changed by changing a thrust ratio and/or a thrust direction of the electric rotors on both sides of the fixed wing. In this way, the flying posture of the aircraft can be flexibly controlled. For example, the flying posture can be converted from vertical take-off posture to level-flying posture, or vice versa.

Optionally, the fuel propulsion units are mounted on the fixed wing, so that the aircraft can be more easily balanced during vertical take-off. For example, when the fuel propulsion units include mechanical rotors driven by the fuel engines, the mechanical rotors may be mounted on front ends of the fixed wing.

Optionally, at least one of the fuel propulsion units includes a mechanical rotor driven by a fuel engine. Optionally, the mechanical rotor may be mounted on a side end of the fixed wing, so that a wing tip of the fixed wing can be wrapped in spiral airflow of the mechanical rotor, and hence the energy consumption during the level flight of the aircraft can be reduced.

Optionally, at least one of the fuel engines is also connected with an electric power generator, the electric power generator can charge batteries for supplying the electric motors with electric power or can directly supply the electric motors with electric power. In this way, adequate power supply can be guaranteed when the operation of the electric rotors is required. Compared with traditional mechanical transmission, the conversion from mechanical energy to electric energy allows more flexible design of multi-rotor layout.

Optionally, the electric power generator is directly connected with a corresponding fuel engine through a coaxial power shaft. The corresponding fuel engine is directly connected with the mechanical rotor through the coaxial power shaft. Such design reduces the weight required by a transmission gear, reduces the energy loss caused by the transmission gear, and improves the reliability.

Optionally, the electric power generator is driven by a corresponding fuel engine through a clutch.

Optionally, at least one of the fuel engines drives the mechanical rotor through a clutch.

Optionally, at least one of the balance, the flying direction and the flying posture of the aircraft may be controlled by the electric rotors, or controlled by the electric rotors and the fuel propulsion units together. As the control via the electric rotors is more flexible, the flight of the aircraft can be more stable and flexible by allowing the electric rotors to participate in controlling at least one of the balance, the flying direction and the flying posture of the aircraft.

Optionally, a rotation direction of at least one of the electric rotors is changeable.

Optionally, a landing gear is mounted on one side of the aircraft, so that the aircraft can taxi on a runway to take off and land.

Optionally, a variable-pitch propeller is used in the fuel propulsion unit.

Optionally, a maximum total thrust of the electric propulsion units does not exceed 50% of a maximum total thrust of the fuel propulsion units. Thus, on one hand, the capacity and the volume of the corresponding electric power generators, batteries and/or electric motors can be reduced, so that the own weight of the aircraft can be reduced. On the other hand, a smooth flight of the aircraft can be still guaranteed even in extreme cases.

Optionally, the electric motor is directly powered by the electric power generator, and a consumption power of the electric power generator does not exceed 50% of an output power of the corresponding fuel engine. Thus, on one hand, the capacity and the volume of the corresponding electric power generator and/or electric motor can be reduced so that the weight of the aircraft can be reduced. On the other hand, a smooth landing of the aircraft still can be guaranteed even in extreme cases.

Optionally, the mechanical rotor is disposed behind the electric rotor, and at least one of the mechanical rotors is overlapped with at least one of the electric rotors. Thus, a backward aerodynamic force produced by the electric rotor can provide a thrust to the mechanical rotor, so as to reduce a drag subjected by the mechanical rotor. Particularly, when the electric power generator driven by the fuel engine drives the electric motor of the electric rotor directly, the above-mentioned layout can ensure the rotation speed of the mechanical rotor and the fuel engine while suddenly increasing the rotation speed of the electric rotor, and hence ensure the stability of an output voltage of the electric power generator.

A flying method of an aircraft is also provided. The aircraft includes a plurality of propulsion units. The plurality of propulsion units includes fuel propulsion units and electric propulsion units. The fuel propulsion units are driven by fuel engines. Each of the electric propulsion units includes an electric rotor driven by an electric motor. A propulsion direction of the fuel propulsion unit is substantially perpendicular to a rotation plane of the electric rotor. In various embodiments, the flying method can include performing a vertical flight of the aircraft by simultaneously operating the fuel propulsion units and the electric propulsion units, in which a balance of the aircraft is controlled by the electric rotor or controlled by the electric rotor and the fuel propulsion unit.

Optionally, the aircraft further includes a fixed wing. The fixed wing is substantially parallel to the propulsion direction of the plurality of propulsion units. The flying method further includes perform a level flight of the aircraft by operating at least part of the propulsion units including the fuel propulsion unit to be cooperated with the fixed wing.

Optionally, the flying method further includes changing a flying posture of the aircraft by changing at least one of a magnitude and/or a direction of a thrust of the electric rotor on the fixed wing.

Optionally, the flying method further includes obtaining a speed required by the level flight by allowing the aircraft to be accelerated along a direction substantially parallel to a substantially planar structure of the fixed wing.

The advantages described in connection with the technical solutions of the aircraft are also applicable to the technical solutions of the flying method.

This Summary is an overview of some of the teachings of the present application and not intended to be an exclusive or exhaustive treatment of the present subject matter. Further details about the present subject matter are found in the detailed description and appended claims. The scope of the present invention is defined by the appended claims and their legal equivalents.

### BRIEF DESCRIPTION OF THE DRAWINGS

Various embodiments are illustrated by way of example in the figures of the accompanying drawings. Such embodiments are demonstrative and not intended to be exhaustive or exclusive embodiments of the present subject matter.

FIG. 1 illustrates an aircraft according an embodiment of the present subject matter.

FIG. 2 illustrates an aircraft according another embodiment of the present subject matter.

FIG. 3 illustrates a flying posture during a vertical flight of an aircraft according an embodiment of the present subject matter.

FIG. 4 illustrates a flying posture during a level flight of an aircraft according an embodiment of the present subject matter.

FIG. 5 illustrates a fuel engine connected to an electric power generator according an embodiment of the present subject matter.

FIG. 6 illustrates a fuel engine connected to an electric power generator according another embodiment of the present subject matter.

FIG. 7 illustrates a fuel engine connected to an electric power generator according to another embodiment of the present subject matter.

FIG. 8 illustrates an aircraft according to another embodiment of the present subject matter.

FIG. 9 illustrates an aircraft according to another embodiment of the present subject matter.

FIG. 10 illustrates an aircraft according to another embodiment of the present subject matter.

FIG. 11 illustrates an aircraft according to another embodiment of the present subject matter.

FIG. 12 illustrates an aircraft according to another embodiment of the present subject matter.

FIG. 13 illustrates an aircraft according to another embodiment of the present subject matter.

### DETAILED DESCRIPTION

The following detailed description of the present subject matter refers to subject matter in the accompanying drawings which show, by way of illustration, specific aspects and embodiments in which the present subject matter can be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The following detailed description is demonstrative and not to be taken in a limiting sense. The scope of the present invention is defined by the appended claims, along with the full scope of legal equivalents to which such claims are entitled.

Unless otherwise defined, the technical terminology or scientific terminology used herein should have the same meaning as commonly understood by one of ordinary skill in the art to which the present subject matter belongs. Likewise, terms like “first,” “second,” etc., which are used in the description and the claims of the present application for invention, are not intended to indicate any sequence, amount or importance, but distinguish various components. The phrases “connect”, “connected”, etc., are not intended to define a physical connection or mechanical connection, but may include an electrical connection, directly or indirectly. “On,” “under,” “left,” “right” or the like is only used to describe a relative positional relationship, and when the absolute position of a described object is changed, the relative positional relationship might also be changed accordingly.

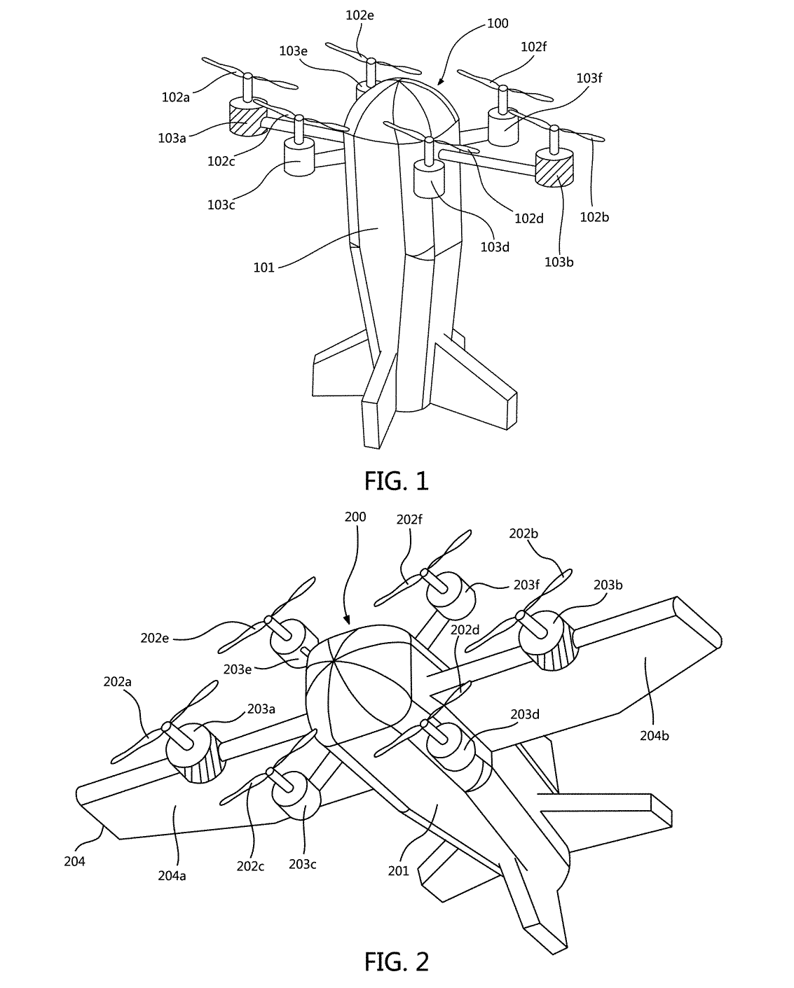

FIG. 1 illustrates an embodiment of an aircraft 100. In various embodiments, the aircraft 100 can be an unmanned aerial vehicle or a manned aircraft. In the illustrated embodiment, the aircraft 100 includes six propulsion units, in which two propulsion units are fuel propulsion units and four propulsion units are electric propulsion units. The two fuel propulsion units are respectively composed of mechanical rotors 102a, 102b, and fuel engines 103a, 103b for driving the mechanical rotors 102a, 102b. The four electric propulsion units are respectively composed of electric rotors 102c-102f, and electric motors 103c-103f for driving the electric rotors 102c-102f. As illustrated in FIG. 1, the aircraft 100 includes a fuselage 101. Six rotors 102a-102f are mounted on the fuselage 101. Among the six rotors, two rotors 102a and 102b are mechanical rotors which are respectively driven by the fuel engines 103a and 103b. The fuel engines 103a and 103b, for instance, can be internal combustion engines or turbine engines, and can be supplied with energy by any petrochemical fuel, hydrogen fuel, or the like. The remaining four of the six rotors 102c-102f are respectively driven by the electric motors 103c-103f. The electric motors can be powered by rechargeable batteries or non-rechargeable batteries, and can also be directly powered by electric power generators driven by the fuel engines, or subjected to a grid-connected power supply from the batteries and the electric power generators driven by the fuel engines together. The advantages of grid-connected power supply is to provide additional power, which ensures more plentiful power during the take-off or maneuvering of the aircraft. The fuel engines can also be used to generate power to charge the batteries to meet future requirements of additional power. In this embodiment, the rotation planes of the mechanical rotors 102a-102b are substantially parallel or consistent with the rotation planes of the electric rotors 102c-102f. Thus, the propulsion direction of the fuel propulsion units is substantially perpendicular to the rotation planes of the electric rotors. In this way, a vertical take-off and landing of the aircraft can be performed by the simultaneous operation of the mechanical rotors and the electric rotors, when needed for example. When the aircraft 100 takes off, the mechanical rotors and the electric rotors are rotated with rotation planes substantially in the horizontal direction, such that a downward thrust is produced by the rotors to drive the aircraft 100 to rise up. It should be understood by those skilled in the art that, in order to balance out a counteracting force produced by the rotation of the rotors, the rotation directions of the mechanical rotors 102a and 102b can be opposite to each other, and the rotors with different rotation directions among the electric rotors 102c-102f can be arranged at the same amount. The flight power required by the aircraft 100 can be supplied by the mechanical rotors 102a-102b and the electric rotors 102c-102f together, or the flight power required by the aircraft 100 can be mainly supplied by the mechanical rotors 102a-102b, while the electric rotors 102c-102f of the aircraft 100 may only function for balance.

When the electric rotors 102c-102f only function for balance, the power of the electric motors of the aircraft 100 can be very small, so do the capacity and the volume of the corresponding electric power generators or batteries, which can reduce the own weight of the aircraft 100. The power of the electric motors can depend on a thrust difference of mass-produced mechanical rotors under the same power. For instance, if a maximum thrust difference of the mass-produced mechanical rotors is 5%, the balance of the aircraft can be substantially guaranteed as long as the maximum total thrust of the electric rotors is higher than 5% of the thrust of the mechanical rotors located at one side (namely 2.5% of the thrust of all the mechanical rotors). The present subject matter can simplify the problem of balance during the vertical take-off of the fuel-powered aircraft by means of electromagnetic energy transmission, and can reduce the power of the electric power generators and the electric motors, so as to decrease the volume and the weight of the fuselage while increasing the payload. In extreme cases, for instance, in an embodiment of two mechanical rotors, when one of the mechanical rotors malfunctions and stalls, the thrust difference of the mechanical rotors can reach 100%, i.e., the thrust of one mechanical rotor is 0 and the thrust of the other one is 100%. In other cases, the thrust difference of the mechanical rotors will be less than 100%. Thus, a smooth flight of the aircraft can be achieved as long as the maximum total thrust of the electric rotors located on one side where malfunction occurs reaches the total thrust of the mechanical rotors driven by the currently running fuel engines (while the electric rotors located on the other side without malfunction can be turned off), i.e., the maximum total thrust of the electric rotors reaches 50% of the maximum total thrust of the two mechanical rotors. Therefore, when the electric rotors only function for balance, the maximum total thrust of the electric rotors may not exceed 50% of the maximum total thrust of the mechanical rotors, i.e., the maximum total thrust of the electric propulsion units do not exceed 50% of the maximum total thrust of the fuel propulsion units. The maximum percentage adopted in practice can also be determined by factors such as the difference level of the mass-produced mechanical rotors and the additional power required for maintaining the maneuverability of the aircraft. In one embodiment, when the electric motors for driving the electric rotors are directly powered by the electric power generators driven by the fuel engines, the consumption power of the electric power generators can be configured not to exceed 50% of the output power of corresponding fuel engines. Such configuration can ensure a smooth landing of the aircraft in extreme cases. For example, in an embodiment of two fuel engines, if one fuel engine malfunctions, the smooth landing of the aircraft can be achieved as long as one half of the power of the other fuel engine is used for driving the electric power generators and then driving the electric motors on the side where the malfunction occurs.

The balance of the aircraft 100 during vertical flight can be achieved by adjusting the thrust of different rotors. For example, when a certain part of the aircraft 100 needs to be raised, the thrust of one or more rotors at or close to this part is increased. When a certain part of the aircraft 100 needs to be lowered, the thrust of one or more rotors at or close to this part is reduced. The change of the thrust of the electric rotors can be achieved by adjusting the rotation speed of the electric motors, and the change of the thrust of the mechanical rotors can be achieved by adjusting throttle and/or by adjusting a pitch of the mechanical rotors (propellers) using variable-pitch propellers. Optionally, the balance of the aircraft 100 can be controlled by the electric rotors only, and can also be controlled by the electric rotors and the mechanical rotors together. In general, the control of the rotation speed of the electric motors is easier and more accurate than the control of the rotation speed of the fuel engines, so the control of the electric rotors is more flexible, and hence the use of the electric rotors to participate in the control of the balance of the aircraft can perform more stable flight of the aircraft. The rotation direction of the electric motors can be configured to be changeable, so a thrust and a pressure can both be generated. The maximum thrust difference required for the balance of the aircraft determines the size and the weight of the electric motors, and also determines the size and the weight of the batteries and the electric power generators. The rotation direction of the electric motors can be changeable, so as to effectively increase the thrust difference, and then reduce the weight of the electric motors, the batteries, and the electric power generators.

In various embodiments, on one hand, as the aircraft 100 includes the fuel propulsion units, it can carry fuel with higher energy density to obtain larger take-off payload, namely it can bear heavier items. On the other hand, as the aircraft 100 includes the electric rotors, it can be designed with simpler structure and can control the balance more easily and accurately, so that the flight of the aircraft 100 can be more stable.

In one embodiment, at least one of the fuel engines of the aircraft 100 can also be connected with an electric power generator (not shown in FIG. 1), and the electric power generator can charge the batteries for supplying the electric motors with electric power, directly supply the electric motors with electric power, or charge the batteries and supply the electric motors with electric power concurrently. In this way, sufficient power supply can be guaranteed for the operation of the electric rotors.

Specific structures of the aircraft 100 are discussed above by way of example, and not by way of restriction. For example, the rotors are not necessarily driven directly by the electric motors or the fuel engines, but can be driven by gear sets or belts that are driven by the electric motors or the fuel engines. It should be understood by those skilled in the art that, each electric motor or fuel engine can drive a plurality of rotors through gear sets or belts. The aircraft does not necessarily include six rotors. It can include a different number of rotors, such as three, four, five, or more than six. The number of the mechanical rotors is not limited to two, but can be one or more than two. The number of the electric rotors is not limited to four either, but can be one, two, three, or more than four. It should be understood by those skilled in the art that, when the number of any kind of rotors is an odd number, a counteracting force of a single rotor without corresponding counter-rotating can be balanced out by adjusting an angle or a thrust of other rotors. In addition, in the embodiment illustrated in FIG. 1, the electric rotors are symmetrically distributed around the fuselage, but the present subject matter is not so limited. The shape of the fuselage is not limited to the shape as illustrated in FIG. 1 either, but can be any other appropriate shapes. The number and the distribution of the rotors, as well as the shape of the fuselage, can be specifically designed by those skilled in the art according to actual demands. In addition, the specific principle and the necessary design in terms of the vertical flight of the aircraft can be the same with those of a conventional helicopter.

FIG. 2 illustrates an embodiment of an aircraft 200. Compared to the aircraft 100, the aircraft 200 further includes a fixed wing component 204. The fixed wing component 204 includes two fixed wings 204a and 204b that are respectively mounted on both sides of a fuselage 201. In FIG. 2, the aircraft 200 also includes six rotors 202a-202f. Among the six rotors, the rotors 202a and 202b are mechanical rotors driven by fuel engines 203a and 203b respectively, and the rotors 202c-202f are electric rotors driven by electric motors 203c-203f respectively. In FIG. 2, the electric rotors 202c-202f are symmetrically distributed around the fuselage 201, wherein the electric rotors 202c, 202d and the electric rotors 202e, 202f are disposed on both sides of the fixed wing 204 respectively. The mechanical rotors 202a and 202b are mounted on front ends of the fixed wing 204, and located on the fixed wings 204a and 204b respectively. Rotation planes of all the rotors 202a-202f are substantially perpendicular to the fixed wing 204, i.e., substantially perpendicular to a plane formed by a length direction and a width direction of the fuselage. Thus, the fixed wings are substantially parallel to the propulsion direction of the propulsion units. The shape and form of the rotors and the fixed wings can be designed similarly to that of propellers and wings of a conventional fixed-wing aircraft. In addition, the shape and form of the fixed wings in the present subject matter can be similar to the shape of the wings of a conventional fixed-wing aircraft. Both surfaces of the fixed wing 204 need to meet aerodynamics principle, so as to allow the fixed wing 204 to lift the aircraft during the level flight of the aircraft 200. It should be noted that, as used herein, “substantially perpendicular” indicates the rotation planes of the rotors 202a-202f do not need to be absolutely perpendicular to the fixed wing 204, and “substantially parallel” indicates the propulsion direction of the propulsion units does not need to be absolutely parallel to the fixed wing, provided that the cooperation of the rotation of the rotors and the fixed wing meets the aerodynamics principle during the level flight of the aircraft 200 to allow the aircraft 200 to obtain a upward lift force and a forward thrust simultaneously.

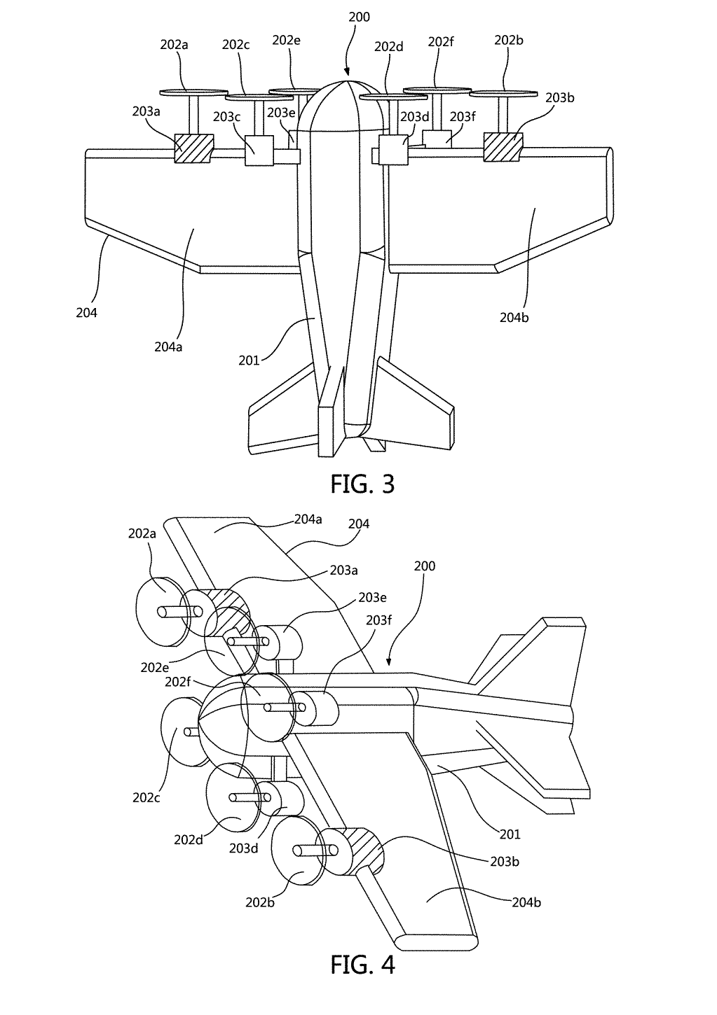

The aircraft 200 can perform static hovering and vertical take-off in a manner similar to a helicopter, and perform rapid level flight similar to a fixed-wing aircraft. FIG. 3 illustrates the flying posture of the aircraft 200 during the vertical flight. As illustrated in FIG. 3, during vertical take-off, the flying posture of the aircraft 200 allows the rotation direction of the rotors 202a-202f being substantially parallel to the ground while the fixed wing 204 being substantially perpendicular to the ground. In such a case, the rotation of the rotors 202a-202f of the aircraft 200 is started to produce a downward thrust to the air, and then the aircraft 200 is lifted by a counteracting force of the air and flies up vertically. As discussed above, the balance of the aircraft 200 can be controlled by the control of a magnitude of the thrust of the rotors 202a-202f. Particularly, the balance of the aircraft 200 is controlled by the control of the rotation speed (for instance, the control is achieved by increasing or reducing the voltage/current applied to the electric motors 203c-203f, and/or, by changing the frequency of alternating current (AC) or pulse inputted into the electric motors) or the rotation direction of the electric rotors 202c-202f. For example, when the aircraft 200 is inclined towards one side where the electric rotors 202c and 202d are located, the flying posture can be adjusted and the balance can be controlled by increasing the rotation speed of the electric rotors 202c, 202d and/or reducing the rotation speed of the electric rotors 202e, 202f. Whether to increase the rotation speed of certain rotors or decrease the rotation speed of certain rotors depends on the requirements of changing or maintaining the altitude of the aircraft. When the aircraft 200, after lift-off, needs to be converted from vertical flight into level flight, it has to change the flying posture, as illustrated in FIG. 4. FIG. 4 illustrates the flying posture of the aircraft 200 during the level flight (showing a perspective view observed from the upper left-front of the aircraft). During level flight, the orientation of the fixed wing 204 is consistent with the flying direction. For example, it can be substantially parallel to the ground, and can also form an included angle with the ground for reasons such as turning. The flying posture is the same as the flying posture of conventional fixed-wing aircraft. The change of the flying posture of the aircraft 200 from vertical flight to level flight can be achieved by controlling the magnitude and/or direction of the thrust of the rotors. For example, when the electric rotors 202c-202f are distributed on both sides of the fixed wing, the flying posture of the aircraft 200 can be changed by the change of the thrust ratio and/or the thrust direction of the electric rotors on both sides of the fixed wing. In the aircraft 200 as illustrated in FIG. 2, the electric rotors 202c, 202d and the electric rotors 202e, 202f are respectively disposed on both sides of the fixed wing 204. As illustrated in FIG. 4, when for example the side provided with the electric rotors 202c and 202d is the lower side during level flight and that the side provided with the electric rotors 202e and 202f is the upper side during level flight, during the flying posture of the aircraft 20 is converted from the vertical take-off state as illustrated in FIG. 3 to the level flight state as illustrated in FIG. 4, the rotation speed of the electric rotors 202e, 202f can be increased and/or the rotation speed of the electric rotors 202c, 202d can be reduced or the rotation direction of the electric rotors 202c, 202d can be reversed. Before the aircraft 200 is converted from vertical take-off posture to level flying posture, usually, the aircraft 200 can be accelerated at first, and then the rotation of corresponding rotors can be adjusted, so as to ensure that the aircraft 200, after level flight, can reach sufficient speed to allow the fixed wing to produce enough lift force.

In various embodiments, the aircraft can optionally change the flying posture by the following ways. For example, before the aircraft 200 is converted from vertical take-off posture to level flying posture, it can be accelerated to fly up or to fly towards one side, at first, so as to ensure that the aircraft 200, after level flight, can reach a speed sufficiently to allow the fixed wing to produce enough lift force. For the aircraft to fly towards one side, it has to reduce the thrust to this side or increase the thrust to the other side, so that an angle of the propulsion direction of all the propulsion units with respect to the horizontal direction is not a right angle, and hence the aircraft 200 can obtain power for moving horizontally. Whether the thrust to a certain side has to be reduced or the thrust to the other side has to be increased depends on the requirements of changing or maintaining the altitude of the aircraft. The direction of an accelerated flight before level flight can be roughly perpendicular to the plane where the fixed wing is located. Alternatively, in order to achieve more effective accelerated flight before level flight, the direction of the accelerated flight can also be roughly parallel to the plane where the fixed wing is located, so as to reduce the drag produced by the fixed wing. For example, the aircraft can perform accelerated flight towards one side provided with the electric rotors 202d and 202f by increasing the rotation speed of the electric rotors 202c, 202e and/or reducing the rotation speed of the electric rotors 202d, 202f. After reaching enough speed, a posture of the fuselage of the aircraft can be converted into roughly parallel to the ground by further increasing the rotation speed of the electric rotors 202c, 202e and/or reducing the rotation speed of the electric rotors 202d, 202f or reversing the rotation direction of the electric rotors 202d, 202f, and then adjusting the angle of ailerons (not illustrated) of the fixed wing in time. At this point, the aircraft can be rotated with its fuselage acting as an axial line by adjusting the angle of the ailerons of the fixed wing to allow the ailerons on both sides of the aircraft to yaw towards different directions, so that the plane where the fixed wing is located can be roughly parallel to the ground and a lift force can be produced. It should be noted that, although in this embodiment the fixed wing includes the ailerons, in various other embodiments a fixed wing may not include ailerons.

Alternatively, a take-off process of the aircraft 200, for example, can be controlled by a control plane (not illustrated) of a tail of the aircraft. For example, after vertical take-off, the aircraft 200 is accelerated to fly away from the ground (the flying direction does not necessarily need to be strictly perpendicular to the ground, and the flying direction can be guaranteed by control of the rotors). When the aircraft reaches enough speed, the control plane of the horizontal tail of the aircraft converts the posture of the aircraft into level flight or other flying postures. It should be understood by those skilled in the art that, the change of the posture of the aircraft can also be achieved by the swing of the control plane of the horizontal tail of the aircraft in combination with the adjustment of the rotors of the aircraft. Alternatively, the change of the posture of the aircraft can also be achieve by the adjustment of the rotors of the aircraft only. It should be noted that, although in the illustrated embodiment the aircraft 200 includes the tail and the control plane, the present subject matter is not so limited.

A landing process of the aircraft is opposite to the take-off process. The aircraft adjusts its flying posture to be vertical by controlling the rotors of the aircraft and/or the control plane of the aircraft, and then the aircraft lands slowly by adjustment of the rotation speed of the rotors or the pitch of the variable-pitch propellers of the aircraft.

In one embodiment, a landing gear can be mounted on one side of the fixed wing. In this way, the aircraft can taxi to take off or taxi to land in proper situations, and the fuel and/or the electric quantity of batteries consumed during taxing, take-off and landing is less than that consumed during vertical take-off and landing, so that the air-range of the aircraft can be increased or the fuel cost can be reduced.

In one embodiment, all the rotors, or the rotors that are not supplied with power during level flight, can be implemented by automatically foldable rotors. These rotors can be automatically folded due to the influence of springs or wind power when not rotating, so as to reduce the drag. In addition, the use of the automatically foldable rotors provides convenience for both of the design and the mounting of the landing gear.

In addition, the flying direction of the aircraft 200 can also be changed or the balance of the aircraft 200 can also be controlled by changing the magnitude and/or direction of the thrust of the rotors. For example, when the aircraft 200 needs to turn left, the thrust of the rotors on the right side can be increased or the thrust of the rotors on the left side can be reduced. During the level flight of the aircraft 200, the mechanical rotors 202a and 202b can generate a rearward thrust, so that a lift force can be provided to the aircraft in virtue of the aerodynamic design of surfaces of the fixed wing 204 with the principle as same as that of common fixed-wing aircraft. The fixed wing 204 can be designed by those skilled in the art according to specific demands. During the process of level flight, the power system of the electric rotors can be turned off. Alternatively, the electric rotors can be turned on to provide auxiliary power and/or to control the balance of the aircraft, and/or to adjust the flying direction and/or the flying posture of the aircraft. When the mechanical rotors and the electric rotors operate simultaneously, on one hand the total power can be increased, and on the other hand the flight speed, flying direction and flying posture can be accurately controlled by utilization of the advantage of the flexible control of the electric rotors.

In one embodiment, the flying posture of the aircraft can also be controlled by the control surfaces on the fixed wing. The control via the control surfaces is similar to the traditional aircraft. The flying posture can be controlled by the interaction between the airflow and the control surfaces, such as the control surfaces of wing flap, aileron, horizontal tail or vertical tail.

The aircraft 200, as illustrated in FIG. 2, not only can perform vertical take-off like a helicopter but also can perform rapid level flight like a fixed-wing aircraft. As the aircraft 200 can be supplied with power for level-flight through the mechanical rotors powered by the fuel engines, the speed and the air-range of the aircraft can be greatly increased.

In one embodiment, at least one of the fuel engines of the aircraft 200 can be also connected with an electric power generator (not shown in FIG. 2), and the electric power generator can charge the batteries for supplying the electric motors with electric power or can directly supply the electric motors with electric power. In this way, adequate power supply can be guaranteed when it needs to operate the electric rotors.

It should be noted that, although specific structures of the aircraft 200 have been discussed above, the present subject matter is not limited to these specifically discussed structures. For example, the mounting of the fixed wing with respect to the fuselage is not limited to that illustrated in FIG. 2, and can adopt any suitable designs. For example, the fuselage can be mounted on one side of the fixed wing so that the fixed wing may not be divided into two parts by the fuselage but is an integral body. The location of the mechanical rotors with respect to the fixed wing is not limited to the case where the mechanical rotors are mounted at the middle of the front end of the fixed wing but can be, for instance, mounted below the fixed wing, as long as it meets the dynamics principle for the flight of the aircraft 200. The aircraft 200 does not necessarily include six rotors, but can also include a different number of rotors, such as three, four, five or more than six rotors. The number of the mechanical rotors is not limited to two but can be one or more than two, and the number of the electric rotors is not limited to four but can be one, two, three or more than four. The electric rotors are not limited to be symmetrically distributed around the fuselage. The shape of the fuselage is not limited to that illustrated in FIG. 2 either, but can be any other suitable shapes. In addition, the specific principle and necessary design in terms of the vertical flight and the level flight of the aircraft 200 can be as same as those of a conventional helicopter and a conventional fixed-wing aircraft. Specific designs can be made by those skilled in the art by following established principles.

It should be understood by those skilled in the art that, each fuel engine or electric motor can drive a plurality of rotors through gear sets or belts. For example, the aircraft may only include one fuel engine which drives two rotors with opposite rotation directions disposed at two end portions of the fixed wing by means of transmission of bevel/ring gears and shafts.

In one embodiment, the fuel engine can also drive the electric power generators, charge the batteries of the electric rotors or directly supply the electric rotors with electric power. When the fuel engine also drives the electric power generators, it can directly drive its own rotors (or propellers; according to the present subject matter, the rotor and the propeller indicate the same, namely blades capable of rotating) and drive the electric power generators by belts, chains and/or gears. Alternatively, the fuel engine can also directly drive the electric power generators, and drive the rotors by belts, chains and/or gears. Alternatively, the fuel engine can respectively drive the rotors and the electric power generators through belts, chains and/or gears. However, considering that the aircraft has strict requirements on the weight and the reliability of all the components, the driving means most suitable for the aircraft is that the fuel engine simultaneously drives the rotors and the electric power generators through a coaxial power shaft. The coaxial power shaft can be an integral shaft, and can also be a plurality of coaxial shafts connected together. It should be understood by those skilled in the art that, these coaxial shafts can be connected through numerous ways (for instance, various kinds of couplers). These coaxial power shafts can be mutually connected through clutches which can selectively cut off the power supply to the electric power generators or the rotors. The clutches are also suitable for the transmission means through belts, chains and/or gears. The use of the clutches can effectively allocate the power of the fuel engines.

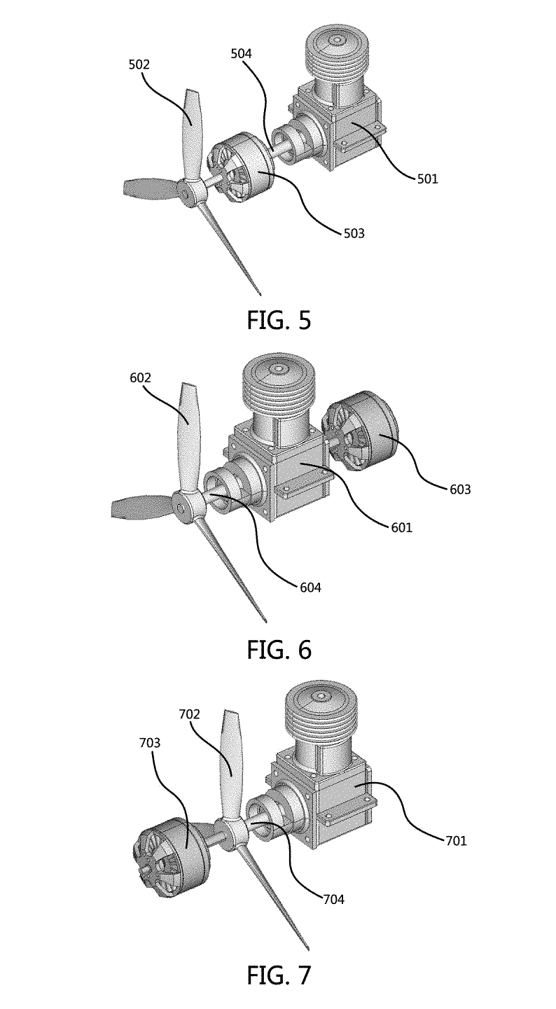

FIG. 5 illustrates a reciprocating engine 501 connected to an electric power generator 503 and a rotor 502 through a power shaft 504. FIG. 6 illustrates a reciprocating engine 601 connected to an electric power generator 603 and a rotor 602 through a power shaft 604. FIG. 7 illustrates a reciprocating engine 701 connected to an electric power generator 703 and a rotor 702 through a power shaft 704. In FIGS. 5-7, the electric power generators are respectively disposed at different locations of the engines and the rotors. Such design reduces the required weight of the transmission gear, and meanwhile reduces the energy loss caused by the transmission gear, and hence improves the reliability. The specific structures shown in FIGS. 5-7 are illustrated by way of example, and not by way of restriction. The engine can be any fuel engine, for instance, internal combustion engine, turbine engine or jet engine. When a jet engine is used as the fuel engine, the power shaft is only directly connected with the electric power generator but not connected with the rotors (propellers). In addition, the power shaft can also be connected with more than one electric power generator.

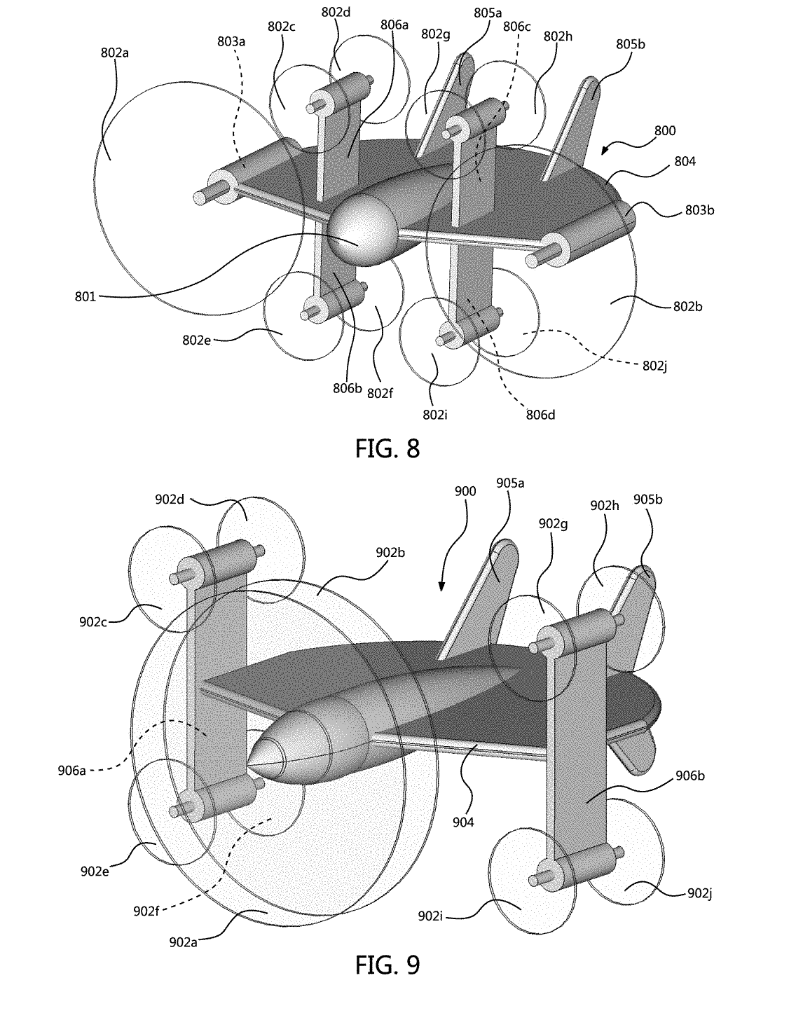

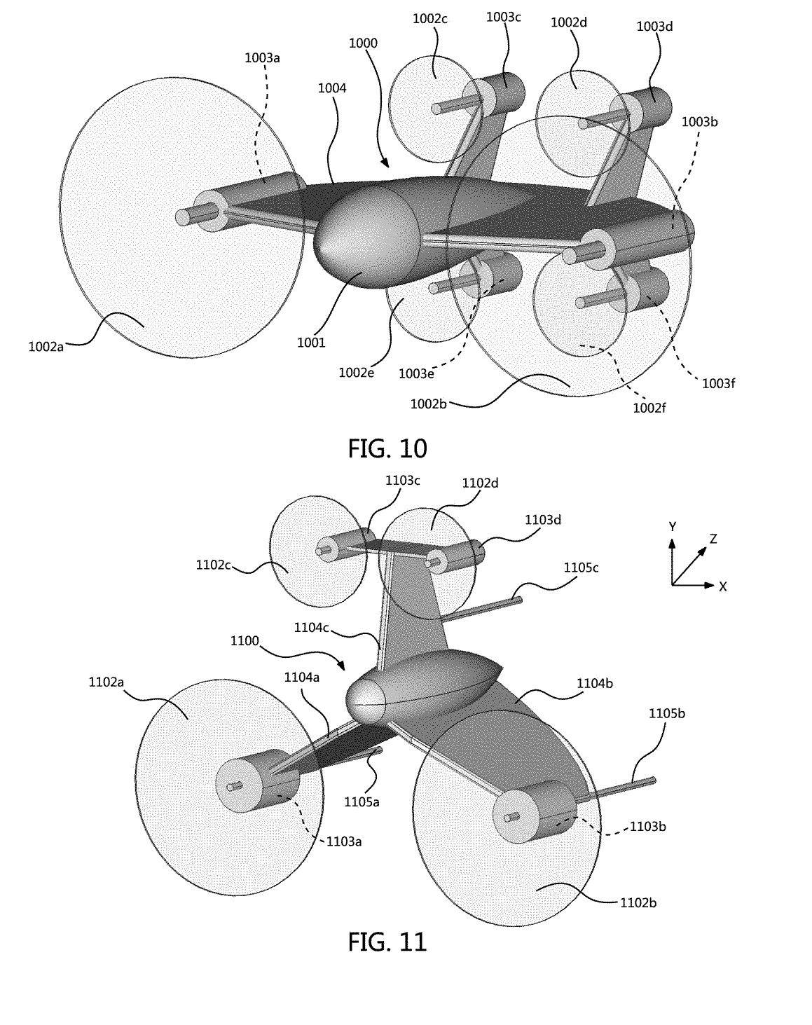

FIGS. 8-11 each illustrate an embodiment of an aircraft according to the present subject matter. In the embodiment illustrated in FIG. 8, an aircraft 800 includes a fuselage 801. A fixed wing 804 is mounted on the fuselage 801. Two tails 805a and 805b are mounted at rear ends of the fixed wing 804. Two fuel power systems are mounted on end portions of both sides of the fixed wing 804 and respectively composed of mechanical rotors 802a and 802b and fuel engines 803a and 803b. Four supports 806a-806d are mounted on the fixed wing 804 in a direction perpendicular to the fixed wing 804. Two electric rotors 802c and 802d, 802e and 802f, 802g and 802h, or 802i and 802j are respectively mounted on each support. Each electric rotor can be driven by an independent electric motor. Alternatively, several or all the electric rotors can be driven by a single electric motor through a coaxial power shaft or through a transmission gear. For example, two electric rotors at ends of a support are driven by the same electric motor. These electric motors can be disposed at end portions of the supports. The main difference between the embodiment illustrated in FIG. 9 and the embodiment illustrated in FIG. 8 is the location arrangement of the mechanical rotors and the electric rotors. In the embodiment illustrated in FIG. 9, an aircraft 900 includes two supports 906a and 906b for supporting electric rotors 902c, 902d, 902e, 902f, 902g, 902h, 902i, and 902j are respectively disposed on end portions of both sides of a fixed wing 904, while the two mechanical rotors 902a and 902b are disposed on front ends of the fuselage. The two coaxial mechanical rotors 902a and 902b can be driven by a single fuel engine which drives the two coaxial mechanical rotors to rotate in opposite directions through a gear set. The main difference between the embodiment illustrated in FIG. 10 and the embodiment illustrated in FIG. 8 is in the number and the location of the electric rotors. In the embodiment illustrated in FIG. 10, an aircraft 1000 includes four electric rotors 1002c, 1002d, 1002e, and 1002f that are respectively mounted on two tails, and can be respectively driven by four electric motors 1003c, 1003d, 1003e, and 1003f. In the embodiment illustrated in FIG. 11, an aircraft 1100 includes three fixed wings 1104a, 1104b, and 1104c. Fuel propulsion units are mounted on end portions of the two fixed wings 1104a and 1104b at a lower side, and are respectively composed of mechanical rotors 1102a, 1102b and fuel engines 1103a, 1103b. Two electric propulsion units are mounted on the fixed wing 1104c at an upper side through supports perpendicular to the fixed wing 1104c, and are respectively composed of electric rotors 1102c and 1102d and electric motors 1103c and 1103d. Support devices 1105a, 1105b, and 1105c are respectively mounted at the rear end of the three fixed wings and configured to support the aircraft 1100 before the vertical take-off of the aircraft 1100. Among the three fixed wings, the fixed wings 1104a and 1104b mainly function to provide a lift force for level flight; and the fixed wing 1104c, similar to a vertical tail of a traditional aircraft, not only supports the two electric propulsion units but also stabilizes the flying direction. The mechanical rotors 1102a and 1102b can adopt variable-pitch propellers with opposite rotation directions, and a tilt balance in the Y-axis direction during vertical take-off can be controlled by continuous correction of a pitch of the two rotors, or controlled by continuous adjusting the speed of two rotors if fix-pitch propellers are used. The electric rotors 1102c and 1102d rotate in opposite directions, and the tilt balance of the aircraft in the X-axis direction can be controlled by controlling the rotation speed of the two electric motors. The electric rotors 1102c and 1102d can be located on the same plane as illustrated in the figure (namely placed on the left and the right, respectively), and can also be coaxial arranged (namely placed on the front and at the rear, respectively). After the vertical take-off of the aircraft 1100, the aircraft 1100 can be converted from vertical posture to level-flying posture by increasing the rotation speed of the electric rotors 1102c and 1102d.

The fuel propulsion units illustrated in FIGS. 1-4 and FIGS. 8-11 each include rotors (propellers), i.e., the power of the aircraft is provided by driving the rotors through the fuel engines. These fuel propulsion units are illustrated and discussed by way of example, and not by way of restriction. The fuel engines can also be engines which do not drive the propellers, e.g., turbofan engines or jet engines. In such cases, a fuel propulsion unit includes the engines but not the rotors. In various embodiments, the propulsion direction of the fuel power system is always substantially perpendicular to the rotation direction of the electric rotors and roughly parallel to the plane where the fixed wing is located, regardless of the type of the fuel engines. During the vertical take-off of the aircraft, the propulsion direction of the fuel power system is roughly perpendicular to the ground. During the level flight of the aircraft, the propulsion direction of the fuel power system is roughly parallel to the flying direction.

Additionally, in various embodiments, when the fuel propulsion unit includes rotors, variable-pitch rotors (variable-pitch propellers) can be used. The pitch (pitch angle) of the variable-pitch propeller is adjustable. Given the same rotation speed, the thrust can be increased or reduced by increasing or reducing the pitch, and the consumption power of the fuel engines will be increased or reduced correspondingly. Various embodiments adopt the variable-pitch propellers which not only can conveniently control the balance of the aircraft but also can effectively utilize the power of the fuel engines. For example, during the level flight of the aircraft, the electric motors can be turned off to reduce the energy loss caused by the energy conversion of the electric power generators. In such a case, the pitch of the variable-pitch propellers can be increased so that the rotors can more effectively utilize all the power output by the fuel engines. When the fight vehicle is in the vertical flying posture, the power of the electric motors can be supplied from the electric power generators. In such case, the pitch of the variable-pitch propellers can be reduced, so that the rotation speed of the fuel engines can be increased and hence the electric power generators can output enough power to drive the electric motors.

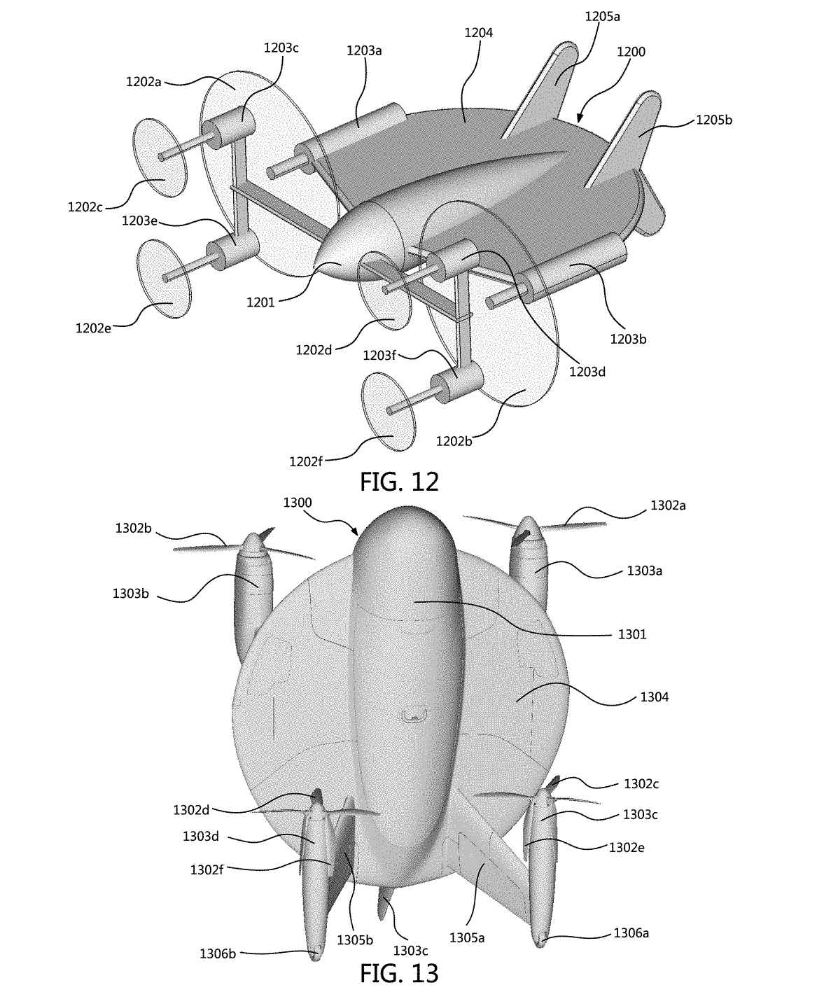

In various other embodiments, mechanical rotors can be disposed behind the electric rotors, and at least one mechanical rotor is overlapped with at least one electric rotor. In the embodiment illustrated in FIG. 12, four electric rotors 1202c, 1202d, 1202e, and 1202f are respectively mounted on a front side of an aircraft 1200. Two mechanical rotors 1202a and 1202b are disposed behind the electric rotors 1202c, 1202d, 1202e, and 1202f (as used herein, the terms “front” and “behind” indicate the directions determined by the flying posture of the aircraft during level flight), and the electric motors and the mechanical rotors are overlapped. Thus, the backward aerodynamic force produced by the electric rotors can provide a thrust to the mechanical rotors, so as to reduce the drag of the mechanical rotors. Particularly when the electric power generators that are driven by the fuel engines directly drive the electric motors of the electric rotors, the above layout can guarantee the rotation speed of the mechanical rotors and the fuel engines while suddenly increasing the rotation speed of the electric rotors, and hence ensure the stability of the output voltage of the electric power generators. The experiences of the inventor indicate that, without adopting the above layout, when the rotation speed of the electric rotors is suddenly increased, the total load of the mechanical rotors and the electric power generators driven by the fuel engines will be increased along with the load of the electric power generators, which can reduce the rotation speed of the fuel engines and suddenly decrease the output voltage; and with adoption of the above layout, the backward thrust of the electric rotors will compensate for the suddenly increased load of the fuel engines to a certain extent by propelling the mechanical rotors, which ensures the stability of the instantaneous output power of the electric power generators.

In the embodiment as illustrated in FIG. 13, an aircraft 1300 includes a fuselage 1301, a fixed wing 1304 that is mounted on the fuselage 1301, two V-shape tails 1305a and 1305b that are mounted at rear ends of the fixed wing 1304, and two fuel propulsion units are mounted on end portions of both sides of the fixed wing 1304 and respectively composed of mechanical rotors 1302a and 1302b and fuel engines 1303a and 1303b. Two electric rotors 1302c and 1302d are respectively mounted on each end of the tail 1305a and 1305b. Each electric rotor is driven by one of an independent electric motors 1303c and 1303d. When the electric motors are not powered on, the two electric rotors 1302c and 1302d are folded to the position 1302e and 1302f. Another bottom tail 1303c is mounted on the bottom of the fuselage 1301. When the aircraft 1300 is landed, the wheels 1306a and 1306b mounted on the two V-shape tails 1305a and 1305b and the bottom tail 1303c support the aircraft 1300 to stand on the ground. The wheels 1306a and 1306b are provided for the ease of moving the aircraft on the ground manually. In one embodiment, another wheel is installed on bottom tail 1303c to allow the aircraft to taxi on the ground by controlling the rotors 1302a, 1302b, 1302c and 1302d.

While wheels mounted on the tail fins of the aircraft is illustrated with the aircraft in FIG. 13 only, any aircraft illustrated and discussed in this document, including each of the aircraft 800, 900, 1000, 1100, and 1200 as illustrated in FIGS. 8-12, can include such wheels mounted on the tail or tail fins, i.e., on the support devices.

While electric propulsion units each including an electric motor and one or more electric rotors driven by the electric motor are specifically discussed above. It should be understood by those skilled in the art that in the various embodiments as discussed in this document, each electric rotor can be replaced by an electric fan. Thus, each “electric rotor” as discussed above should be understand as an “electric rotor or electric ducted fan”. Accordingly, the electric propulsion unit can each include one or more electric rotors or electric ducted fans powered by an electric motor. A ducted fan can also be considered as one or more special layers of rotor mounted within a cylindrical shroud or duct.

It should be understood by those skilled in the art that various modifications, combinations, partial combinations and replacements may be made to the present invention according to design requirements and other factors, and shall fall within the scope of protection of the present invention as long as they fall within the scope of the appended claims or equivalents thereof.

What is claimed is:

1. An aircraft, comprising:
one or more fuel propulsion units driven by one or more fuel engines and having a propulsion direction; and
one or more electric propulsion units each including an electric motor and one or more electric rotor or electric ducted fans driven by the electric motor and having a rotation plane that is substantially perpendicular to the propulsion direction of the one or more fuel propulsion units.

2. The aircraft of claim 1, further comprising a fixed wing.

3. The aircraft of claim 2, wherein during a level flight, the aircraft is propelled by the one or more fuel propulsion units or propelled by the one or more fuel propulsion units and the one or more electric propulsion units simultaneously.

4. The aircraft of claim 2, wherein the one or more electric propulsion units comprise a plurality of electric propulsion units, and the electric rotors or electric ducted fans of the plurality of electric propulsion units are distributed on both sides of the fixed wing.

5. The aircraft of claim 2, further comprising further one or more fixed wings, wherein the one or more fuel propulsion units include a plurality of fuel propulsion units mounted on at least two fixed wings of the fixed wing and the one or more further fixed wings, the one or more electric propulsion units include a plurality of electric propulsion units, and the electric rotors or electric ducted fans of the plurality of electric propulsion units are mounted on both sides of at least one remaining fixed wing of the fixed wing and the one or more further fixed wings.

6. The aircraft of claim 2, wherein at least one of the one or more fuel propulsion units comprises a mechanical rotor driven by the fuel engine.

7. The aircraft of claim 1, further comprising one or more electric power generators each connected to at least one fuel engine of the one or more fuel engines to generate electric power.

8. The aircraft of claim 7, further comprising a battery to power the one or more electric propulsion units, and wherein the electric power generator is configured to charge the battery, power the one or more electric propulsion units directly, or charge the battery and power the one or more electric propulsion units directly, and the one or more electric propulsion units are powered by one or more of the battery, the one or more electric power generators, or a grid-connected power supply.

9. The aircraft of claim 7, wherein the electric power generator is directly connected to a corresponding fuel engine of the one or more fuel engines through a coaxial power shaft.

10. The aircraft of claim 9, wherein the one or more fuel propulsion units comprises a mechanical rotor directly connected to the corresponding fuel engine through the coaxial power shaft to be driven by the corresponding fuel engine through the coaxial power shaft.

11. The aircraft of claim 7, wherein the electric power generator is driven by a corresponding fuel engine of the one or more fuel engines through a clutch.

12. The aircraft of claim 7, wherein the one or more fuel propulsion units comprises a mechanical rotor connected to a fuel engine of the one or more fuel engines through a clutch to be driven by the fuel engine through the clutch.

13. The aircraft of claim 7, wherein a consumption power of the one or more electric power generators is equal to or less than 50% of an output power of a corresponding fuel engine.

14. The aircraft of claim 1, wherein at least one of a balance, a flying direction, or a flying posture of the aircraft is controlled by the one or more electric rotors or electric ducted fans or by the one or more electric rotors or electric ducted fans and the one or more fuel propulsion units.

15. The aircraft of claim 1, a maximum total thrust of the fuel propulsion units equals or exceeds a maximum total thrust of the electric propulsion units.

16. The aircraft of claim 1, further comprising a landing gear mounted on one side of the aircraft to allow the aircraft to taxi on a runway to take off and land.

17. The aircraft of claim 1, further comprising an automatically foldable rotor.

18. The aircraft of claim 1, wherein the one or more electric rotors or electric ducted fans has a changeable rotation direction.

19. The aircraft of claim 1, wherein the one or more propulsion units comprise one or more variable-pitch propellers.

20. The aircraft of claim 1, further comprising a tail and a wheel on the tail.

21. The aircraft of claim 1, wherein at least one of the one or more fuel propulsion units comprises a mechanical rotor driven by a fuel engine of the one or more fuel engines, positioned behind an electric rotor or electric ducted fan of the one or more electric propulsion units, and overlapping with that electric rotor or electric ducted fan.

22. A flying method of an aircraft including one or more fuel propulsion units and one or more electric propulsion units, the one or more fuel propulsion units driven by one or more fuel engines and having a propulsion direction, the one or more electric propulsion units each including one or more electric rotors or electric ducted fans driven by an electric motor and having a rotation plane substantially perpendicular to the propulsion direction of the one or more fuel propulsion units, the flying method comprises:
performing a vertical flight of the aircraft by simultaneously operating the one or more fuel propulsion units and the one or more electric propulsion units, wherein a balance of the aircraft is controlled by the one or more electric rotors or electric ducted fans or controlled by the one or more electric rotors or electric ducted fans and the one or more fuel propulsion units.

23. The flying method of claim 22, wherein the aircraft further comprises a fixed wing having a plane substantially parallel to the propulsion direction of the one or more fuel propulsion units, and further comprising performing a level flight of the aircraft by operating the one or more fuel propulsion units in cooperation with the fixed wing.

24. The flying method of claim 23, wherein the fixed wing comprises control surfaces, and further comprising changing a flying posture of the aircraft by performing one or more of:
changing at least one of a magnitude and a direction of a thrust of an electric rotor or electric ducted fan of the one or more electric propulsion units; or
controlling control surfaces of the fixed wing.

25. The flying method of claim 23, further comprising obtaining a speed required by level flight by allowing the aircraft to be accelerated along a direction substantially parallel to the plane of the fixed wing.
